(19) United States
(12) Patent Application Publication
(10) Pub. No.: US 2017/0306152 A1
(43) Pub. Date: Oct. 26, 2017

(54) Multifunctional Additives

(71) Applicant: ICL Performance Products LP, St. Louis, MO (US)

(72) Inventors: Olga Shulga, St. Louis, MO (US); René Maldonado, St. Louis, MO (US); Larry Larson, St. Louis, MO (US)

(21) Appl. No.: 15/492,854

(22) Filed: Apr. 20, 2017

Related U.S. Application Data
(60) Provisional application No. 62/326,280, filed on Apr. 22, 2016.

(51) Int. Cl. C08L 95/00; C08K 5/521; C08K 9/10

(52) U.S. Cl. CPC C08L 95/00; C08K 9/10; C08K 5/521; C08K 2201/016; C08L 2555/40; C08K 2201/003

(57) ABSTRACT

This disclosure provides for compositions and applications thereof of multifunctional additive systems for asphalt modifications. These systems comprise multiple functional additives in one source, and thus can reduce or eliminate the need for multiple redundant equipment, such as pumps and meters for the addition of each additive. In certain embodiments, the additive system is such that it can be stored and/or transferred without the need for or with reduced need for mixing.

### CROSS-REFERENCE TO RELATED APPLICATIONS

This application is a Non-Provisional Application which claims the benefit of U.S. Provisional Patent Application No. 62/326,280, filed on Apr. 22, 2016, which is incorporated herein by reference in its entirety.

### BACKGROUND

The incorporation of materials into an inert matrix can provide an alternative route for the blending of incompatible materials and the controlled release of the active ingredients. Incorporation of a functional ingredient within a matrix material is utilized in the pharmaceutical and fertilizer industries. This is in addition to the development of cleaning compositions and paints and coating formulations. Examples of incorporated materials include solid inorganic particles, enzymes, bleach, reaction catalysts, etc. Different inert matrix materials can be used for encapsulation depending on the active ingredients. Examples include waxes, polyethylene glycol (PEG), and others.

H₂S is a naturally occurring gas contained in many of the world's crude oils. It is also formed in the refining process by degradation of sulfur-containing compounds at high temperature. Asphalt is the heaviest of the products coming out of the refinery and typically the product in which sulfur compounds concentrate the most. High temperatures (300° F.-400° F.) are used to store and transport asphalt. These conditions promote cracking of sulfur-containing compounds and therefore, the formation of H₂S. When dealing with hydrocarbons containing large amounts of H₂S, the safety of personnel involved in its storage, handling and transportation, and safety of the community is of utmost importance. Exposure to very low levels of H₂S can result in significant health problems. H₂S is particularly insidious because it deadens the sense of smell at concentrations as low as 30 ppm, and death can occur within a few breaths at concentrations of 700 ppm. Due to the high toxicity of H₂S, there are regulatory limits for H₂S exposure on federal, state, and local levels.

The standard practice to reduce or eliminate H₂S concentration in gas, crude and refined oil is to treat these materials with H₂S scavengers. For example, H₂S scavenging can occur according to the following reaction:

H2S+ZnO→ZnS↓+H2O (1)

ZnS is inert material and remain in the asphalt at all times.

Metal-based H₂S scavengers are typically used for asphalt. H₂S scavengers are mostly used at oil refineries prior to shipment of asphalt to asphalt plants. At the plant, the asphalt may undergo further modification, such as with cross-linking polymers, acid, or both. When SBS-type of polymers are involved, elemental sulfur is used as a cross-linker to provide more efficient modification. When sulfur is exposed to high temperature, however, H₂S may be generated spontaneously.

Various asphalt modifiers/additives may be not be compatible with each other. For example, liquid polyphosphoric acid (PPA) may react with other asphalt modifiers/additives, such as H₂S scavengers.

The simplification of processes in the production and modification of asphalt, such as fewer process steps, fewer storage containers, etc., is commercially advantageous. Also, asphalt producers prefer that additives be in a liquid form for transfer and addition, such as by pumping. An example of this prior art type system is shown in FIG. 1 that is generally indicated by numeral 10, with a storage container for a phosphoric acid, e.g., liquid polyphosphoric acid (PPA), 12, a sulfur slurry 14, anti-strip additive 16 and other additives 18. Each of these storage containers 12, 14, 16, and 18 are connected to pump/meter combinations 20, 22, 24 and 26, respectively, that provide these materials to an asphalt tank 28.

Thus there remains a need for a product that can be handled as a liquid and that can perform multiple functions, for example, allowing combinations of incompatible materials.

### SUMMARY

This section provides a general summary of the disclosure, and is not a comprehensive disclosure of its full scope or all of its features. The present invention is generally directed to an acid composition for asphalt compositions including either a rheologically modifying acid or a rheologically modifying acidic solution and encapsulated additive particles.

In an aspect of the present invention, an acid composition for asphalt compositions is disclosed. The acid composition includes a rheologically modifying acid or a rheologically modifying acidic solution, encapsulated additive particles, where the encapsulated additive particles have an average diameter size of from about 0.5 mm to about 10 mm and are in a ratio of encapsulated additive particles to the rheologically modifying acid or the rheologically modifying acidic solution of from about 0.1:1 to about 3:1 for utilization in asphalt compositions.

In another aspect of the present invention, an acid composition for asphalt compositions is disclosed. The acid composition includes a rheologically modifying acid or a rheologically modifying acidic solution, encapsulated additive particles, where the encapsulated additive particles have an average diameter size of from about 1 mm to about 5 mm and are in a ratio of encapsulated additive particles to the rheologically modifying acid or the rheologically modifying acidic solution of from about 0.5:1 to about 1.5:1 for utilization in asphalt compositions.

In still another aspect of the present invention, an acid composition for asphalt compositions is disclosed. The acid composition includes a rheologically modifying acid or a rheologically modifying acidic solution, encapsulated additive particles, where the encapsulated additive particles have an average diameter size of from about 2 mm to about 4 mm and are in a ratio of encapsulated additive particles to the rheologically modifying acid or the rheologically modifying acidic solution of from about 0.8:1 to about 1:1 for utilization in asphalt compositions.

In yet another aspect of the present invention, a method of preparing a modified asphalt is disclosed. The method includes providing a source of the phosphoric acid composition described above in a storage container and pumping the phosphoric acid composition from the storage container to a mixing container wherein the phosphoric acid composition and an asphalt are combined in the mixing container.

In still yet another aspect of the present invention, a method of preparing a modified asphalt is disclosed. The method includes providing a source of the phosphoric acid composition described above in a storage container and injecting into a conduit containing the asphalt, wherein the phosphoric acid composition and an asphalt are combined in the conduit for shipment.

These are merely some of the innumerable aspects of the present invention and should not be deemed an all-inclusive listing of the innumerable aspects associated with the present invention. These and other aspects will become apparent to those skilled in the art in light of the following disclosure and accompanying drawings. The description and specific examples in this summary are intended for purposes of illustration only and are not intended to limit the scope of the present disclosure.

### BRIEF DESCRIPTION OF THE DRAWINGS/FIGURES

For a better understanding of the present invention, reference may be made to the accompanying drawings in which:

FIG. 1 is a typical prior art asphalt modifying process in which multiple storage containers, containing multiple different additives/modifiers, require multiple pump/meter equipment to add the additives to the asphalt tank; and

FIG. 2 shows a multifunctional additive system, comprising multiple additives/modifiers (even if components are incompatible), that can be stored in a single storage container and requires only a single pump/meter to add the multiple additives to the asphalt tank.

### DETAILED DESCRIPTION

### Definitions

The term “a” or “an” entity refers to one or more of that entity; for example, “a modifier” is understood to represent one or more modifiers. As such, the terms “a” (or “an”), “one or more,” and “at least one” can be used interchangeably herein.

Furthermore, “and/or” where used herein is to be taken as specific disclosure of each of the two specified features or components with or without the other. Thus, the term “and/or” as used in a phrase, such as “A and/or B” herein, is intended to include “A and B,” “A or B,” “A” (alone), and “B” (alone). Likewise, the term “and/or” as used in a phrase, such as “A, B, and/or C,” is intended to encompass each of the following embodiments: A, B, and C; A, B, or C; A or C; A or B; B or C; A and C; A and B; B and C; A (alone); B (alone); and C (alone).

It is understood that wherever aspects are described herein with the language “comprising,” otherwise analogous aspects described in terms of “consisting of” and/or “consisting essentially of” are also provided.

All methods described herein can be performed in any suitable order unless otherwise indicated herein.

No language or terminology in this specification should be construed as indicating any non-claimed element as essential or critical.

Unless defined otherwise, technical and scientific terms used herein have the same meaning as commonly understood by one of ordinary skill in the art to which this disclosure is related.

Numeric ranges are inclusive of the numbers defining the range.

The headings provided herein are not limitations of the various aspects or aspects of the disclosure, which can be had by reference to the specification as a whole.

As used herein, the term “asphalt” refers to any asphalt bottoms fraction, as well as naturally occurring asphalts, tars and pitches. The term “bottoms fraction” refers to a crude fraction having a flash point of about 70° F. or greater. The term “asphalt” may be used interchangeably with the term “bitumen.” The term “asphaltic concrete” refers to asphalt utilized as a binder with appropriate aggregate added, such as that, which is typically used as a paving material.

As used herein, “average diameter size” is determined by have a set of diameter measurements that are summed and then divided by the number of measurements in the set.

### Overview

This disclosure provides for compositions and applications thereof of multifunctional additive systems for asphalt modifications. These systems comprise multiple functional additives in one source, and thus can reduce or eliminate the need for multiple redundant equipment, such as pumps and meters for the addition of each additive.

In certain embodiments, the additive system is such that it can be stored and/or transferred without the need for or with reduced need for mixing to keep its components incorporated so that, for example, in the context of an asphalt producing operation, the additives can be transferred by pumping from one location, such as a storage container, to another, such as an asphalt mix tank or mixing container. Contemplated applications include, but are not limited to asphalt paving, asphalt roofing, and other applications, such as paints and coating. In addition, the asphalt can be injected into a conduit containing the asphalt, wherein the phosphoric acid composition and an asphalt are combined in the conduit for shipment. From the conduit, the asphalt can be passed to a transfer device, e.g., truck.

In certain embodiments, an additive system consists of two or more components where the first component is an inorganic acid that is used as a carrier for a second component. In certain embodiments, the carrier is a liquid phase which allows, for example, the pumping of the components. In certain embodiments, the carrier only contains a limited amount of water that depends on the nature of carrier. For example, the carrier is substantially devoid of water for safety. In certain embodiments, the carrier does not contain compounds that would compromise one or more of the constituents of the second component. For example, where the second component comprises an encapsulating wax, the carrier does not comprise hydrocarbon oils that would eventually dissolve the wax.

In certain embodiments, the liquid carrier is an asphalt additive, such as a rheologically modifying acid or a rheologically modifying acidic solution. In certain embodiments, the inorganic acid is a phosphoric acid, examples of which include orthophosphoric acid, pyrophosphoric acid, tripolyphosphoric acid, polyphosphoric acid (PPA), and mixtures thereof, e.g., two or more. Other types of rheologically modifying acid solutions include acid anhydride, diphosphorus pentaoxide (P₂O₅), sulfuric acid (H₂SO₄), derivatives of H₂SO₄, R—(COO)x-SO₃H, boric acid and a combination thereof.

In certain embodiments, the carrier has a high density or higher density compared to the second component and/or a high viscosity to help suspend the second component in the carrier component. This can aid in allowing the additive system to be stored and/or transferred, for example, in the context of asphalt production, without the need or with less need for mixing and so that the system is pumpable. In certain embodiments, polyphosphoric acid can be used as the carrier.

In certain embodiments, the second component comprises one or more functional additives (sometimes referred to herein as simply an “additive”). A functional additive serves some function, but need not be a reactive agent. For example, in some embodiments, the functional additive is an inert pigment or dye, such as carbon black or other inert ingredient. In some embodiments, multiple functional additives, such as multiple inert additives, multiple reactive additives, or both inert and reactive additives, are included in the second component. In some embodiments, the functional additive is one or more asphalt modifiers. The multiple additives are preferably, but not necessarily, at least two.

A functional additive may not necessarily be compatible with the carrier, e.g., it could be reactive with the carrier. For example, when PPA is selected as the carrier and the second component comprises an inorganic salt/oxide which reacts with PPA. Thus, in certain embodiments, certain ingredients of the second component, whether incompatible or not with the carrier, are incorporated, such as encapsulated, into another material or matrix to shield them from the carrier. This “encapsulating material” can serve the purpose of preventing, delaying, reducing, and the like the contact and/or reaction between materials in the system, or with asphalt or other downstream compositions, until a point where release/contact and/or reaction of a functional additive of the second component is desired.

In certain embodiments, an encapsulating material encapsulates a functional additive to form the second component, which is referred to herein as an “encapsulated additive particle” (also referred to interchangeably as an encapsulated additive “pellet” or “bead”). This can include a hydrocarbon, ceramic or glass, among other materials. One type of illustrative, but nonlimiting, hydrocarbon includes wax. Wax is an ideal encapsulating material since the melting point can be chosen as desired, e.g., greater than 70° C. and it is a relatively unreactive material. Nonlimiting examples of wax include animal waxes, vegetable waxes, mineral waxes, petroleum derived waxes, synthetic waxes and any combination thereof.

Various polymers and high softening point asphalt materials can also be used as the encapsulating material. Preferably, but not necessarily, these polymers are water insoluble. It is important to note that “encapsulation” does not need to be absolute, that is, not all of the surface area of the functional additive need to be encompassed by the encapsulating material. For example, in some embodiments, the additive is interspersed within the encapsulating material, including at the surface of the encapsulated additive particle. Thus, some of the functional additive of an encapsulated additive particle can be exposed, such as exposed to the carrier component. It is understood that the more incompatible and/or reactive the functional additive is with the carrier, the less exposure of the functional additive will be acceptable for the system to operate efficiently. In some embodiments, the functional additive is entirely encapsulated, such as wherein the functional additive forms a core that is entirely encapsulated with the encapsulating material. Some embodiments can comprise forming a first encapsulated additive particle of additive and encapsulating material, and then further coating the first particle in additional encapsulating material to reduce or completely eliminate exposure of the functional additive. Such methods are particularly useful when the amount of exposure of the additive in the first particle is unacceptably high, such as instances in which the additive is highly reactive with the carrier. Additional coatings with the encapsulating material can be performed as needed. Illustrative, but nonlimiting, examples of water insoluble polymers include acryl polymers, vinyl polymers, lactic-based polymers, glycolic acid-based polymers, lactic and glycolic acid-based polymers, polysaccharides, cellulose-derived polymers, poly (β-amino ester) polymers, mixed inorganic-organic polymers, ethylene copolymer resins, silicones, cellulose, ethylcellulose, chitin, collagen, nylon, polyalkylcyanoacrylate, polyethylene, polyhydroxyethyl methacrylate, polyhydroxypropylethyl methacrylate, polymethyl methacrylate, polyvinyl alcohol-co-methacrylate, poly(vinyl chloride, polyisobutene, polyurethane, silicon rubber, sodium alginate, polyethylene glycol, gelatin, pitch, resin and any combination thereof.

As noted, encapsulation can keep the functional additive from reacting with the carrier and also control its release, either before or after the additive system is added to asphalt. Thus, in certain embodiments, this allows for the introduction of the asphalt modifier PPA along with PPA-reactive materials, such as inorganic oxides in one system (even though they may be incompatible with each other), thus eliminating the need to separately store and/or separately add these components to asphalt, and also can provide a time delay between reaction of PPA and asphalt and release of encapsulated additive.

The components of the additive system comprising the encapsulated additive particles can comprise a single type of encapsulated additive particle that comprises a single type of functional additive. The components of the additive system comprising the encapsulated additive particles can also comprise a single type of encapsulated additive particle that comprises multiple functional additives within the additive particle, such as two, three, four, five, or more functional additives encapsulated within an encapsulated additive particle. The component of the additive system comprising the encapsulated additive particles can also comprise multiple distinct types of encapsulated additive particles that comprise different functional additives or different combinations of functional additives, such as two, three, four, five, or more functional additives are present in the system, but not all encapsulated within the same encapsulated additive particles. Although it will be understood that there will be some variability from encapsulated particle to encapsulated particle, where the distinction is made for compositional purposes herein, a difference between encapsulated particles can also be the amount and/or ratio of functional additives.

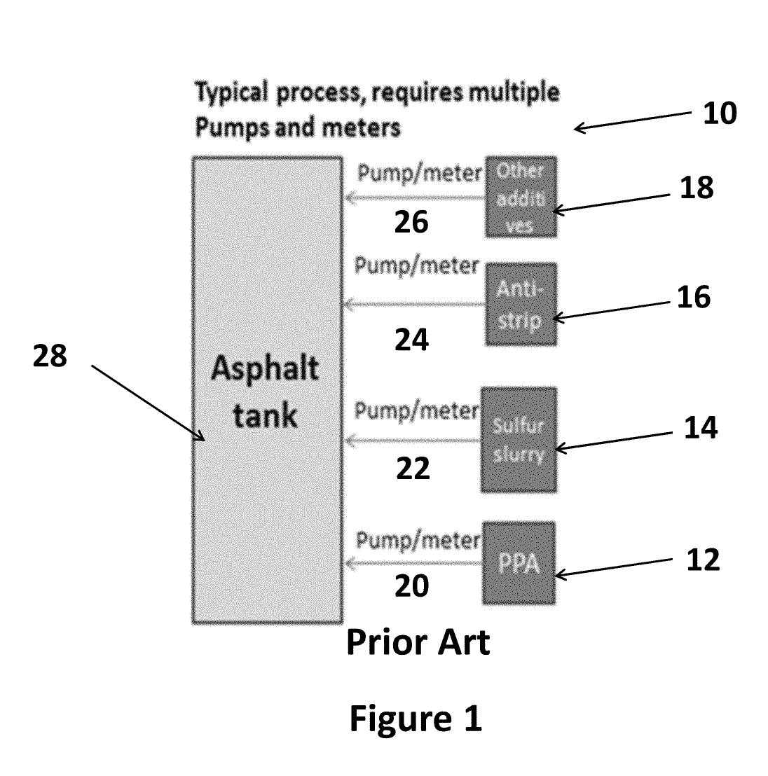

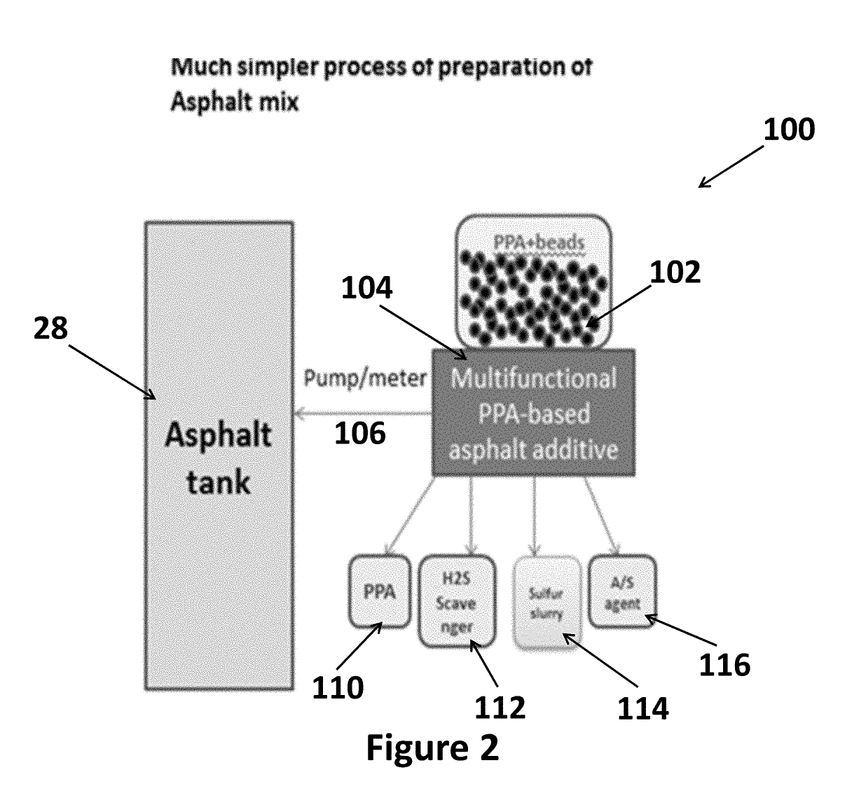

This system is shown in FIG. 2 and is generally indicated by numeral 100. A storage container of encapsulated beads and phosphoric acid, e.g., polyphosphoric acid, is indicated by numeral 102 that forms a multifunctional phosphoric based asphalt additive 104 that can be put through a single pump/meter combination 106, in marked contrast to FIG. 1, that provide these multifunctional asphalt additives 104 to an asphalt tank 28. These encapsulated additives can include as merely illustrative examples, in addition to a phosphoric acid 110, e.g., polyphosphoric acid, but are not limited to, H₂S scavenger material 112, a sulfur slurry 114, and an antistripping agent 116.

### Multifunctional Additive System Compositions

Provided herein are multifunctional additive system compositions. In certain embodiments, the system comprises a phosphoric acid composition comprising a phosphoric acid and encapsulated additive particles. In certain embodiments, the encapsulated additive particle average diameter size is less than 0.5 mm. In certain embodiments, the encapsulated additive particle average diameter size is from about 0.5 mm to about 10 mm. In certain embodiments, the encapsulated additive particle average diameter size is greater than 10 mm. In certain embodiments, the encapsulated additive particle average diameter size is from any of about 0.5 mm, 1 mm, 2 mm, 3 mm, 4 mm, 5 mm, 6 mm, 7 mm, 8 mm, or 9 mm to any of about 1 mm, 2 mm, 3 mm, 4 mm, 5 mm, 6 mm, 7 mm, 8 mm, 9 mm or 10 mm. In certain embodiments, the encapsulated additive particle average diameter size is from about 1 mm to about 5 mm. In certain embodiments, the encapsulated additive particle average diameter size is from about 2 mm to about 4 mm. In certain embodiments, the encapsulated additive particle average diameter size is about 0.5 mm, 1 mm, 2 mm, 3 mm, 4 mm, 5 mm, 6 mm, 7 mm, 8 mm, 9 mm and 10 mm and all sizes in between. In certain embodiments, the encapsulated additive particle average diameter size is about 1 mm, 2 mm, 3 mm, 4 mm or 5 mm. In other embodiments, the encapsulated additive particle average diameter size is from about 2 mm to about 4 mm.

In certain embodiments, the ratio of encapsulated additive particles to phosphoric acid is from about 0.1:1 to about 3:1. In certain embodiments, with any of the average diameter sizes above, the ratio of encapsulated additive particles to phosphoric acid is from any of about 0.1:1, 0.2:1, 0.3:1, 0.4:1, 0.5:1, 0.6:1, 0.7:1, 0.8:1, 0.9:1, 1;1, 1.1:1, 1.2:1, 1.3:1, 1.4:1, 1.5:1, 1.6:1, 1.7:1, 1.8:1, 1.9:1, 2.0:1, 2.1:1, 2.2:1, 2.3:1, 2.4:1, 2.5:1, 2.6:1, 2.7:1, 2.8:1, 2.9:1 or 3.0:1. In certain embodiments, the ratio of encapsulated additive particles to phosphoric acid is from about 0.5:1 to about 1.5:1 and in other embodiments the ratio of encapsulated additive particles to phosphoric acid is from about 0.8:1 to about 1.0:1.

In certain embodiments, the phosphoric acid comprises at least one of orthophosphoric acid, pyrophosphoric acid, tripolyphosphoric acid, or polyphosphoric acid. In certain embodiments, the phosphoric acid is a mixture of at least two polyphosphoric acids selected from the group consisting of orthophosphoric acid, pyrophosphoric acid, tripolyphosphoric acid, and polyphosphoric acid. In certain embodiments, the phosphoric acid composition comprises an additional acid, such as sulfonic acid. Other types of rheologically modifying acid that are not phosphoric include acid anhydride, diphosphorus pentaoxide (P₂O₅), sulfuric acid (H₂SO₄), derivatives of H₂SO₄, R—(COO)x-SO₃H, boric acid and a combination thereof.

In certain embodiments, the encapsulated additive particle comprises an additive encapsulated by a hydrocarbon or a wax. In certain embodiments, the encapsulated additive particle comprises from about 10 wt % to about 90 wt % wax of the total particle, from about 25 wt % to about 75 wt % additive of the total particle, and from about 40 wt % to about 60 wt % additive of the total particle. In certain embodiments, the encapsulated additive particle comprises from any of about 10 wt %, 25 wt %, 30 wt %, 35 wt %, 40 wt %, 45 wt %, 50 wt %, 55 wt %, or 60 wt % to any of about 40 wt %, 45 wt %, 50 wt %, 55 wt %, 60 wt %, 65 wt %, 70 wt %, or 75 wt % wax of the total particle and from about 25 wt %, 30 wt %, 35 wt %, 40 wt %, 45 wt %, 50 wt %, 55 wt %, 60 wt %, 65 wt %, or 70 wt % to any of about 40 wt %, 45 wt %, 50 wt %, 55 wt %, 60 wt %, 65 wt %, 70 wt %, or 75 wt % additive of the total particle. In certain embodiments, the encapsulated additive particle comprises from about 30 wt % to about 50 wt % wax of the total particle and from about 50 wt % to about 70 wt % additive of the total particle. In certain embodiments, the encapsulated additive particle comprises from about 50 wt % to about 70 wt % wax of the total particle and from about 30 wt % to about 50 wt % additive of the total particle. In certain embodiments, the encapsulated additive particle comprises from about 40 wt % to about 50 wt % wax of the total particle and from about 50 wt % to about 60 wt % additive of the total particle.

For example, in an illustrative but nonlimiting embodiment, the encapsulated additive particles have an average diameter size of from about 2 mm to about 4 mm, the encapsulated additive particle comprises from about 40 wt % to about 60 wt % wax of the total particle or from about 50 wt % to about 60 wt % additive of the total particle, and the ratio of encapsulated additive particles to phosphoric acid is from about 0.8:1 to about 1:1.

Without being bound by theory; depending on the density of the additive and the density of the wax, the amount of additive in the encapsulated additive particle, the average size of the encapsulated particle, the ratio of particles to carrier, and the density and/or viscosity of the carrier (e.g., phosphoric acid), the buoyancy and/or packing characteristics of the encapsulated additive particles within the system can be manipulated to achieve a composition in which the additive particles do not require mixing or require less mixing to prevent them from settling and/or separating from the carrier. In addition to also being able to influence the viscosity of the system, this allows for certain embodiments to be flowable and/or pumpable without the need or with less need to agitate the system to keep the additive particles acceptably incorporated throughout the carrier component.

The viscosity of a phosphoric acid composition disclosed anywhere herein can vary. In certain embodiments, the composition has a viscosity, of from about 500 cP to about 100,000 cP. Viscosity was measured with a viscosity cup, which is a gravity device that permits the timed flow of a known volume of liquid passing through an orifice located at the bottom. Under ideal conditions, this rate of flow would be proportional to the kinematic viscosity (expressed in stokes and centistokes) that is dependent upon the specific gravity of the draining liquid.

Moreover, the viscosity may be lower when using, for example, 85% orthophosphoric acid or higher, for example, when using 115% PPA. In certain embodiments, the phosphoric acid composition has a viscosity of from any of about 500 cP, 1,000 cP, 2,500 cP, 5,000 cP, 10,000 cP, 20,000 cP, 30,000 cP, 40,000 cP, 50,000 cP, 60,000 cP, 70,000 cP, 80,000 cP, 90,000 cP to any of about 1,000 cP, 2,500 cP, 5,000 cP, 10,000 cP, 20,000 cP, 30,000 cP, 40,000 cP, 50,000 cP, 60,000 cP, 75,000 cP, or 100,000 cP. In certain embodiments, the composition has a viscosity of from about 5,000 cP to about 75,000 cP. In certain embodiments, the composition has a viscosity of from about 10,000 cP to about 60,000 cP.

In an illustrative, but nonlimiting example, the encapsulated additive particles have an average diameter size of from about 2 mm to about 4 mm, the encapsulated additive particle comprises from about 40 wt % to about 50 wt % wax of the total particle and from about 50 wt % to about 60 wt % additive of the total particle, the ratio of encapsulated additive particles to phosphoric acid is from about 0.8:1 to about 1:1, and the viscosity of the phosphoric acid composition in from about 10,000 cP to about 60,000 cP.

The density of the encapsulated additive particles, along with other considerations, help to determine the buoyancy and/or packing of the particles in the carrier component. If the particles are too dense in comparison to other factors, the particles will sink, thus requiring mixing or some other form of agitation to keep them distributed in a useful manner. If the particles are close to or less than the density of the carrier component (e.g, phosphoric acid), they will have a tendency to remain suspended. This will allow the composition to be transferred, such as by pumping, without the need or with less of a need for mixing/agitation, thus simplifying processes utilizing the composition. In certain embodiments, the density of the encapsulated additive particles is from about 0.1 g/ml to about 6.0 g/m. Density was measured using volume of beads that displaces certain volume of water in the graduated cylinder in what is identified as the water displacement method. In certain embodiments, the density of the encapsulated additive particles is from any of about 0.1 g/ml, 0.5 g/ml, 1.0 g/ml, 1.5 g/ml, 2.0 g/ml, 2.5 g/ml, 3.0 g/ml, 3.5 g/ml, 4.0 g/ml, or 5.5 g/ml to any of about 1.0 g/ml, 1.5 g/ml, 2.0 g/ml, 2.5 g/ml, 3.0 g/ml, 3.5 g/ml, 4.0 g/ml, 5.5 g/ml or 6.0 g·ml. In certain embodiments, the density of the encapsulated additive particles is from about 0.5 g/ml to about 4.0 g/ml. In certain embodiments, the density of the encapsulated additive particles is from about 1.0 g/ml to about 3.0 g/ml. The density of the encapsulated additive particles will in part be determined by the density of the additive (as well as, e.g., the amount of additive in the particle). In certain embodiments, high density additive materials, such as those having a density of from about 1.8 to about 2.1 g/cm³ can be used. One example of a high density material is carbon black. In certain embodiments, low density additive materials, such as those having a density of from about 0.4 to about 0.5 g/cm³ can be used. One example of a low density material is MgO (R-150 from Israel, Specialty Minerals). Thus, in certain embodiments, the encapsulated additive can have a density of from about 0.4 g/cm³ to about 2.1 g/cm³.

In an illustrative, but nonlimiting embodiment, the encapsulated additive particle average diameter size is from about 2 mm to about 3 mm and a density of from about 1.0 g/ml to about 2.5 g/ml. In certain of such embodiments, the ratio of encapsulated additive particles to phosphoric acid is from about 0.8:1 to about 1:1. The encapsulated additive can optionally be a multifunctional asphalt modifier.

Representative examples of additives include flame retardants, corrosion inhibitors, odor suppressants, chemical modifiers, polymers, pigments and dyes, and catalysts (e.g., ferric chloride). In certain embodiments, the additive is an asphalt modifier. Representative examples of asphalt modifiers include H₂S scavengers or control agents, fillers, rubbers, plastic, rubber and plastic combinations, antioxidant, polymers, hydrocarbons, waste materials, rheology modifying agents, chemical modifying agents, polymer cross-linking agents, antistripping agents, odor masking agents or suppressants, oils for asphalt modification, silicones, compaction aids/warm mix additives, waste materials, antioxidants, anti-coking agents, emulsifiers, asphalt extenders, oxidizing agents, catalysts, asphalt penetration modifiers, additional organic or inorganic acids, polyphosphoric acid, pyrophoric iron preventers, flash point modifiers, and peptizing agents, and combinations thereof with specific examples of all of which are well known in the field of asphalt modification.

In certain embodiments, the asphalt modifier is selected from the group consisting of sulfur, cross-linking agents, anti-stripping agents, H₂S control agent, odor suppressants, chemical modifiers, polymer cross-linking agents, catalysts, pyrophoric iron preventers, and a combination thereof. Illustrative, but nonlimiting, examples of fillers include minerals, crusher fines, lime, cement, fly ash, carbon black and any combination thereof. Illustrative, but nonlimiting, examples of extenders include sulfur and lignin and any combination thereof. Illustrative, but nonlimiting, examples of rubber include natural latex, synthetic latex, polychloroprene latex, block polymer, styrene-butadiene-styrene, styrene-butadiene rubber, reclaimed rubber, and any combination thereof. Illustrative, but nonlimiting, examples of polymer include polyethylene, polypropylene, ethylene acrylate copolymer, ethyl-vinyl-acetate, polyvinyl chloride, ethylene propylene, polyolefin, ethylene copolymer resins, reactive elastomeric terpolymers, reactive ethylene terpolymers, an ester group, methyl acrylate, ethyl acrylate, butyl acrylate, glycidyl methacrylate, terpolymers of ethylene, and any combination thereof. Illustrative, but nonlimiting, examples of fiber includes rock wool, polypropylene, polyester, fiberglass, mineral, cellulose, synthetic fiber and any combination thereof. Illustrative, but nonlimiting, examples of oxidant includes manganese salt and illustrative, but nonlimiting examples of an antioxidant may include lead compounds, carbon, calcium salts and any combination thereof. Illustrative, but nonlimiting, examples of a hydrocarbon includes recycling oil, rejuvenating oil, mineral oil, hard asphalt, natural asphalt and any combination thereof. Illustrative, but nonlimiting, examples of antistripping agents include amines, phosphate esters, phosphonates, lime and any combination thereof. Illustrative, but nonlimiting, examples of waste materials include roofing shingles, recycled tires, glass and any combination thereof. Moreover, illustrative, but nonlimiting, examples of a cross-linker includes a sulfur crosslinker a sulfur-free crosslinker and a combination thereof.

Certain applications are directed to the reduction of H₂S gas release in asphalt. This can be accomplished by the use of H₂S scavengers.

Commodity H₂S scavenger products include peroxides (oxidize H₂S), amines (neutralize H₂S) and caustic solutions (neutralize H₂S). The application of these commodity products is associated with various issues. For example, the application of peroxides leads to the oxidation of other sulfur-containing compounds, which leads to degradation of the oil. Reaction of H₂S with amines leads to the production of thermally unstable compounds that degrade, producing H₂S. The application of caustic solutions, typically NaOH/KOH, leads to corrosion problems.

Specialty chemicals include water-soluble scavengers, such as triazine-based compounds. These are used at temperatures below 200° F. and are used to treat crude oil, flare gas, and liquefied petroleum gas (LPG). They are not, however, generally recommended for asphalt

Oil-soluble scavengers are typically amine based. These can be applied at wide range of temperatures, e.g., up to 350° F. They can be used to treat viscous heavy oils and residues.

Metal-based scavengers are generally used at temperatures 350° F. or higher and high H₂S concentrations. Metal-based H₂S scavengers are typically used for asphalt. Metal-based H₂S scavengers include zinc and iron oxides and inorganic salts, for example, zinc oxide, zinc carbonate, zinc octoate, zinc citrate, and zinc borate. Major producers of H₂S scavengers are Nalco Company having a place of business at 1601 W. Diehl Road, Naperville, Ill. 60563 and Baker Hughes Incorporated having a place of business at 2929 Allen Parkway, Houston, Tex. 77019. H₂S scavengers are mostly used at oil refineries prior to shipment of asphalt to asphalt plants.

At the asphalt plant, asphalt may undergo further modification with cross-linking polymers, acid, or both. Certain embodiments can serve as an asphalt modifier due to the presence of PPA and also will reduce H₂S exposure at the asphalt plants due to the presence of scavenging agents, such as copper oxide (CuO), to control the release of H₂S gas. In certain embodiments, the encapsulated additive may include an inorganic material such as a chloride, borate, phosphate, sulfate, bromide, iodide, fluoride or carbonate or a combination thereof.

In other certain embodiments, the encapsulated additive is an inorganic oxide. In certain embodiments, the inorganic oxide is CuO, zinc oxide (ZnO), a ferric (Fe) oxide, magnesium oxide (MgO) or a combination thereof. In certain embodiments, the inorganic oxide is CuO. In certain embodiments, any phosphoric acid composition disclosed herein further comprises an inorganic material selected from the group consisting of chlorides, borates, and carbonate. For example, ferric chloride may be used for roofing applications. In certain embodiments, the inorganic material is encapsulated in an encapsulated additive particle.

The encapsulating material in which the additive is contained helps to determine the interaction that the additive has with the carrier component and other downstream components, for example, when the additive system is added to asphalt. The encapsulating material can influence that amount of additive that is initially contacted with its surrounding environment. The encapsulating material can be chosen to release the additive over time, at a certain time, and/or under a certain condition. For example, the encapsulating material can be chosen to decompose or otherwise release the additive over time. The encapsulating material can be chosen to degrade or otherwise release the additive upon contact with a certain substance. The encapsulating material can also be chosen to melt or otherwise release the additive at a certain temperature. This may be particularly useful in asphalt applications where certain asphalt production steps are performed at defined temperatures. In certain embodiments, the encapsulating material has a melting point of greater than 40° C. In other embodiments, the encapsulating material has a melting point of greater than 70° C. In still other certain embodiments, the encapsulating material has a melting point of greater than 100° C. In certain embodiments, the encapsulating material comprises a wax.

In certain embodiments, the encapsulated additive particles comprise a mixture of different types of encapsulated additive particles. For example, the mixture can comprise at least two, three, four, or more different additives contained in separate particles. The individual encapsulated particles themselves can each comprise a mixture of different types of encapsulated additive particles. Thus, the encapsulated additive particles can comprise any of various combinations of particles comprising separate additives mixed together and particles comprising multiple additives mixed together. Optionally, the ingredients for the mixture of different types of encapsulated additive particles do not react together.

For example, the encapsulated additive particles can comprise a mixture of separate particles comprising either an H₂S scavenger or a polymer cross-linking agent. For example, the encapsulate additive particles can comprise particles comprising an H₂S scavenger and a polymer cross-linking agent encapsulated in the same particles. For example, the encapsulated additive particles can comprise particles comprising an H₂S scavenger and a polymer cross-linking agent encapsulated in the same particles and an antistripping agent encapsulated in separate particles. In certain illustrative, but nonlimiting, embodiments, the encapsulated additive particles comprise a mixture of at least CuO as one additive and, additionally, an asphalt modifier as a second additive. In other illustrative, but nonlimiting, embodiments, the mixture of encapsulated additive particles at least comprises additive particles comprising CuO as the additive and separate additive particles comprising a nonreactive asphalt modifier as the additive.

In certain embodiments, an encapsulated additive particle comprises an additive encapsulated by a polymer. In certain embodiments, the polymer is selected from the group consisting of ethyl cellulose, polyvinyl alcohol, gelatin, and sodium alginate. In certain embodiments, the polymer is a thermosetting polymer. In certain embodiments, the polymer has a melting point as described for certain encapsulating materials described elsewhere herein.

### Methods of Asphalt Production

Provided herein are methods of producing asphalt comprising asphalt modifiers/additives. In certain embodiments, the method comprises combining a phosphoric acid composition disclosed herein with the asphalt to form a mixture of the asphalt and the phosphoric acid composition. In certain embodiments, the method improves the rheological, physical, and/or environmental properties of an asphalt in comparison to an identical asphalt that has not been combined with the phosphoric acid composition. In certain embodiments, after the phosphoric acid composition and asphalt is combined, the mixture is brought to a temperature that is sufficient to release the additive from the encapsulated additive particle, such as at or above the melting point of the encapsulating material, e.g., melt a wax. In certain embodiments involving a wax, the wax can have a melting point of not less than 40° C., not less than 70° C. and not less than 100° C. as illustrative examples. An illustrative, but nonlimiting, example includes encapsulated additive particles including a plurality of ingredients that do not react together.

In certain embodiments, the amount of the phosphoric acid composition combined with the asphalt is from about 0.5 wt % to about 2.5 wt % of the total weight of the asphalt after the addition of the phosphoric acid composition. In certain embodiments, the amount of the phosphoric acid composition combined with the asphalt is from any of about 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, or 1.5 wt % to any of about 1.0 wt %, 1.1 wt %, 1.2 wt %, 1.3 wt %, 1.4 wt %, 1.5 wt %, 2.0 wt %, or 2.5 wt % of the total weight of the asphalt after the addition of the phosphoric acid composition. In certain embodiments, the amount of the phosphoric acid composition combined with the asphalt is from about 0.1 wt % to about 1.5 wt % or 2.0 wt % of the total weight of the asphalt after the addition of the phosphoric acid composition. In certain embodiments, the amount of the phosphoric acid composition combined with the asphalt is from about 1.2 wt % to about 1.3 wt % of the total weight of the asphalt after the addition of the phosphoric acid composition.

Provided herein are methods of preparing an asphalt comprising asphalt modifiers/additives that are simplified by the ability to pump multiple additives into the asphalt. In certain embodiments, the method comprises providing a source of a phosphoric acid composition disclosed anywhere herein where the phosphoric acid composition is in a storage container, such as a storage tank. Due to the viscosity and/or the distribution of the encapsulated additive particles in the phosphoric acid composition achieved by the various parameters disclosed herein, the composition comprising multiple functional components is pumped from the storage container to a mixing container wherein the phosphoric acid composition and an asphalt are combined in the mixing container. In certain embodiments, there is no need to mix the phosphoric acid composition to redistribute the encapsulated additive particles in order to pump the phosphoric acid composition with the requisite amount of encapsulated additive particles. Thus, in certain embodiments, the phosphoric acid composition is not mixed in the storage container prior to being pumped into the mixing container.

Also provided herein are methods of preparing an asphalt comprising asphalt modifiers/additives that are simplified by the ability to pump multiple additives into the asphalt. In certain embodiments, the method comprises providing a source of a phosphoric acid composition disclosed anywhere herein where the phosphoric acid composition is in a storage container, such as a storage tank. Due to the viscosity and/or the distribution of the encapsulated additive particles in the phosphoric acid composition achieved by the various parameters disclosed herein, the composition comprising multiple functional components is pumped from the storage container into a conduit wherein the phosphoric acid composition and an asphalt are combined in the conduit for shipment. The conduit may be connected in fluid relationship to a truck for transport of the phosphoric acid composition.

In certain embodiments, there is no need to mix the phosphoric acid composition to redistribute the encapsulated additive particles in order to pump the phosphoric acid composition with the requisite amount of encapsulated additive particles. Thus, in certain embodiments, the phosphoric acid composition is not mixed in the storage container prior to being pumped into the mixing container.

As described in detail elsewhere herein, in certain embodiments, a plurality of asphalt modifiers/additives are contained in the encapsulated additive particles of the phosphoric acid composition in the storage container. Thus, in certain embodiments, the entirety of the asphalt additives, or a majority of the asphalt additives, or at least 80% of the asphalt additives added to the asphalt in the mixing tank, are provided only by additives contained in a single source of multifunctional asphalt additives, such as a single source of the phosphoric acid composition, such as from a single storage container or a plurality of storage containers holding the same phosphoric acid composition. The combination of the phosphoric acid composition with the asphalt improves the rheological, physical, and/or environmental properties of the asphalt in comparison to an identical, but unmodified, asphalt.

In certain embodiments, the encapsulated additive particles comprise a mixture of different types of encapsulated additive particles in the storage container. For example, the mixture can comprise at least two, three, four, or more different additives contained in separate particles. The individual encapsulated particles themselves can each comprise a mixture of different types of encapsulated additive particles. Thus, the encapsulated additive particles can comprise any of various combinations of particles comprising separate additives mixed together and particles comprising multiple additives mixed together in the storage container.

In addition, provided herein is an asphalt composition that comprises an asphalt, polymer, crosslinking agent, and the phosphoric acid composition disclosed anywhere herein, wherein the additive is CuO, and wherein the asphalt composition has a reduced concentration of H₂S in comparison to an identical asphalt composition prepared without CuO as the additive.

### Examples

### Example 1. Method of Preparation of Wax Beads

Methods were performed in accordance with those widely described in the literature. A dispersion of wax and CuO was prepared by melting wax and mixing it with CuO using a hot stirring plate. Beads were prepared by making small droplets dropped from syringe into a cold surface (e.g., water or release paper).

### Example 2. CuO Load of Encapsulated Particles

TABLE 1

| Composition | Bead size | Observation |
|---|---|---|
| 50% CuO beads | 2-4 mm | Beads take the entire volume of |
| 1:1 mix with PPA | | PPA, used as carriers of PPA into |
| (20 g + 20 g) | | the asphalt. Formulation |
| | | maintains fluidity. Concentration |
| | | of CuO is sufficient to scavenge |
| | | H₂S. No additional mixer is required. |
| 50% CuO beads 1:1 | <1.5 mm | Not fluid, but will quench H₂S. |
| mix with PPA | | |
| (20 g + 20 g) | | |
| 50% CuO beads | 2-4 mm | Fluid, but concentration of CuO |
| 0.5:1 mix with PPA | | will not be sufficient to quench H₂S. |
| 60% CuO beads, | 2-3 mm | Formulation takes the entire volume |
| 0.8:1 (16 g beads + | | of PPA. Maintains fluidity. Will |
| 20 g PPA) | | be more efficient in H₂S scavenging. |
| | | No need for extra mixer. |
| 65% CuO beads | 2-4 mm | Beads and PPA are separated |
| | | with beads being on the bottom |
| | | of the vial. Will be efficient in H₂S |
| | | scavenging, but the formulation |
| | | will require a mixer. |
| 75% CuO beads | 2-4 mm | Formulation will be efficient for |
| | | H₂S scavenging but will require a |
| | | mixer. Also, higher load of CuO |
| | | leads to leaching of CuO out and |
| | | it will undergo a neutralization |
| | | reaction with PPA. |

### Example 3. PPA/Particle Separation

2-3 mm average diameter encapsulated additive particles comprising a 50% CuO load were mixed with 105% PPA at 1:1 ratio and placed in a cylinder. After allowing time to come to equilibrium, the cylinder was bisected and the number of particles (beads) in the top half and the bottom half of the cylinder were counted. Various waxes as identified in Table 2 were used for encapsulation.

TABLE 2

| | Beads count (top) | Beads count (bottom) |
|---|---|---|
| Sasol wax | 82 | 78 |
| Paraffin wax | 76 | 55 |
| Polyethylene wax | 139 | 73 |

For each wax, the number of wax particles in the top of the sample exceeded the number of particles in the bottom of the sample. This demonstrates that when the phosphoric acid composition is stored in a container, the particles resist sinking/settling to the bottom (and may rise slightly to the top), which will allow for the composition to be transferred by pumping without the need or with less need for agitation, such as mixing.

### Example 4. P₂O₅ Content in CuO Particles/PPA Formulations

This example examines the amount of CuO that can be incorporated into encapsulated additive particles without causing a decrease of P₂O₅ content in PPA (Table 3).

TABLE 3

| Sample ID | % P₂O₅ |
|---|---|
| 1. 50% CuO beads + PPA 1:1 10 days Sasol wax | 75.58 |
| 2. 50% CuO beads + PPA 1:1 4 days Trecora | 75.06 |
| 3. 50% CuO beads + PPA 1:1 4 days Sigma wax | 75.18 |
| 4. 50% CuO beads + PPA 1:1 4 days HP wax | 75.33 |
| 5. 65% CuO beads + PPA 1:1 4 days Sigma wax | 74.37 |
| 6. Control 105% PPA | 75.6 |

It was observed that at 50% CuO, no leaching of CuO from the beads was observed as a decrease of P₂O₅ content using various waxes. At 65% CuO load, a slight decrease in P₂O₅% content was observed. This may be an indication of overloads of CuO per bead and, therefore, a neutralization reaction between CuO and PPA.

Higher loading of CuO may be possible, however, neutralization reaction will be more pronounced, and second layer of coating may be required

### Example 5. Encapsulation of Materials with Various Densities

Encapsulation of carbon black: 1.8-2.1 g/cm³ (high density material). 50%:50% (carbon:wax) with Sasol wax was not possible to encapsulate. Not all carbon was moistened by wax. 33%:66% (carbon:wax) formulation looked like a thick paste, prepared large, irregular shaped particles. 25%:75% (carbon:wax) formulation was a much thinner paste and produced large beads.

Encapsulation of MgO (R-150 from Israel, Specialty Minerals): density 0.4-0.5 g/cm³ (low density material). Produced large beads. Possible to make 50:50 mix with wax.

The breadth and scope of the present disclosure should not be limited by any of the above-described exemplary embodiments, but should be defined only in accordance with the following claims and their equivalents.

### REFERENCES

1. “A Novel Freeze Pelletization Technique for Preparing Matrix Pellets” Pharmaceutical Technology October 2004.
2. U.S. Pat. No. 5,550,044
3. U.S. Pat. No. 3,429,958
4. U.S. Pat. No. 5,200,236
5. U.S. Pat. No. 7,157,113
6. EP2885983 A1
7. WO2003016410 A2
8. EP1417266 B1
9. U.S. Pat. No. 5,637,350
10. U.S. Pat. No. 3,773,535 A
11. WO2014078642 A1
12. U.S. Pat. No. 7,862,893 B2
13. U.S. Pat. No. 3,276,857 A
14. U.S. Pat. No. 4,614,599
15. CA1261604
16. U.S. Pat. No. 5,126,151
17. U.S. Pat. No. 5,413,924
18. U.S. Pat. No. 5,643,764
19. U.S. Pat. No. 3,429,958
20. U.S. Pat. No. 4,384,835
21. U.S. Pat. No. 2,758,085

1. An acid composition comprising:
a rheologically modifying acid or a rheologically modifying acidic solution; and
encapsulated additive particles,
wherein the encapsulated additive particles have an average diameter size of from about 0.5 mm to about 10 mm and are in a ratio of encapsulated additive particles to the rheologically modifying acid or the rheologically modifying acidic solution of from about 0.1:1 to about 3:1,
for utilization in asphalt compositions.

2. The composition of claim 1,
wherein the encapsulated additive particles have an average diameter size of from about 1 mm to about 5 mm and are in a ratio of encapsulated additive particles to the rheologically modifying acid or the rheologically modifying acidic solution of from about 0.5:1 to about 1.5:1.

3. The composition of claim 1,
wherein the encapsulated additive particles have an average diameter size of from about 2 mm to about 4 mm and are in a ratio of encapsulated additive particles to the rheologically modifying acid or the rheologically modifying acidic solution of from about 0.8:1 to about 1:1.

4. The composition of claim 1, wherein the rheologically modifying acid is phosphoric acid.

5. The composition of claim 1, wherein the rheologically modifying acid is selected from the group consisting of acid anhydride, diphosphorus pentaoxide (P₂O₅), sulfuric acid (H₂SO₄), derivatives of H₂SO₄, R—(COO)x-SO₃H, boric acid, and combinations thereof.

6. (canceled)

7. The composition of claim 1, wherein the encapsulated additive particle comprises an additive encapsulated by a hydrocarbon.

8-9. (canceled)

10. The composition of claim 7, wherein the hydrocarbon has a melting point of greater than 70° C. and/or is a water insoluble polymer.

11-12. (canceled)

13. The composition of claim 7, wherein the hydrocarbon is a wax.

14. (canceled)

15. The composition of claim 1, wherein the encapsulated additive particle comprises from about 10 wt % to about 90 wt % of the total particle.

16. The composition of claim 1, wherein the encapsulated additive particle comprises from about 25 wt % to about 75 wt % of the total particle.

17. The composition of claim 1, wherein the encapsulated additive particle comprises from about 40 wt % to about 60 wt % of the total particle.

18. The composition of claim 1, wherein the composition has a viscosity of from about 500 cP to about 100,000 cP.

19. The composition of claim 1, wherein the composition has a viscosity of from about 10,000 cP to about 60,000 cP.

20. The composition of claim 1, wherein the density of the encapsulated additive particles is from about 0.1 g/ml to about 6.0 g/ml.

21. The composition of claim 1, wherein the density of the encapsulated additive particles is from about 0.5 g/ml to about 4.0 g/ml.

22. (canceled)

23. The composition of claim 1, wherein the encapsulated additive is a multifunctional asphalt modifier.

24-25. (canceled)

26. The composition of claim 1, wherein the encapsulated additive further comprises an inorganic material selected from the group consisting of chlorides, borates, phosphates, sulfates, bromides, iodides, fluorides, carbonate and combinations thereof.

27. The composition of claim 1, wherein the encapsulated additive is an inorganic oxide.

28-31. (canceled)

32. The composition of claim 1, wherein the encapsulated additive particles comprise a mixture of encapsulated additive particles having a plurality of different additives contained in separate particles.

33. The composition of claim 1, wherein the encapsulated additive particles comprise a plurality of ingredients that do not react together.

34. The composition of claim 32, wherein the mixture of encapsulated additive particles at least comprises additive particles comprising CuO as the additive and at least one separate nonreactive additive particle comprising an asphalt modifier as the additive.

35. A method of preparing a modified asphalt, the method comprising combining the phosphoric acid composition of claim 1, with the asphalt to form a mixture of the asphalt and the phosphoric acid composition.

36. (canceled)

37. A method of preparing a modified asphalt, the method comprising:
i) providing a source of the phosphoric acid composition of claim 1 in a storage container; and
ii) pumping the phosphoric acid composition from the storage container to a mixing container wherein the phosphoric acid composition and an asphalt are combined in the mixing container or injecting the phosphoric acid into a conduit containing the asphalt, wherein the phosphoric acid composition and an asphalt are combined in the conduit for shipment.

38-46. (canceled)
